(19) United States
(12) Patent Application Publication
(10) Pub. No.: US 2012/0069047 A1
(43) Pub. Date: Mar. 22, 2012

(54) IMAGE DISPLAY APPARATUS, IMAGE EDITING APPARATUS, IMAGE DISPLAY PROGRAM, AND IMAGE EDITING PROGRAM

(75) Inventors: Senichi ONODA, Osaka (JP); Yoshiyasu Kado, Nara (JP); Jun Takemura, Osaka (JP)

(73) Assignee: Panasonic Corporation, Osaka (JP)

(21) Appl. No.: 13/082,371

(22) Filed: Apr. 7, 2011

(30) Foreign Application Priority Data
Sep. 17, 2010 (JP) 2010-209968

(51) Int. Cl. G09G 5/00; G06K 9/36

(52) U.S. Cl. 345/619; 382/232

(57) ABSTRACT

An image display apparatus is provided that includes a determination unit and a display management unit. The determination unit is configured to determine whether auxiliary information and still image data are stored together. The auxiliary information is stored to indicate that the still image data has been extracted from encoded moving picture data. The display management unit is configured to display a still image and a mark on a display unit. The still image is displayed based on the still image data, and the mark is displayed once the determination unit has determined that the auxiliary information and the still image data are stored together. The mark is also displayed to indicate that the still image data has been extracted from encoded moving picture data.

### CROSS-REFERENCE TO RELATED APPLICATIONS

This application claims priority under 35 U.S.C. §119 to Japanese Patent Application No. 2010-209968, filed on Sep. 17, 2010. The entire disclosure of Japanese Patent Application No. 2010-209968 is hereby incorporated herein by reference.

### BACKGROUND

1. Technical Field

The technology disclosed herein relates to image display apparatuses, image editing apparatuses, image display programs, and image editing programs. In particular, the technology disclosed herein relates to image display apparatuses, image editing apparatuses, image display programs, and image editing programs associated with processes for capturing still images from moving pictures that are being reproduced.

2. Background Information

Japanese Patent application, W-2004-312495A, discloses a digital camera having a function for capturing a still image from a moving picture that is being reproduced.

Incidentally, in general, still image data extracted from moving picture data that has already been encoded has the risk of having less information than still image data generated through a normal shooting process. For example, it is often the case that data indicating the shooting conditions, such as the shutter speed, the F-stop value, and so on is added to the latter type of still image data, but such shooting condition data is omitted from the former type of still image data. Meanwhile, the former type of still image data sometimes has a lower level of image quality than the latter type of still image data. This is because some information is lost when compressing data into moving picture data, a single frame of a still image is recorded at a higher image quality than a single frame of a moving picture, and so on.

With the digital camera disclosed in JP-2004-312495A, it is difficult to distinguish still image data extracted from moving picture data that has already been encoded from still image data generated through a normal shooting process.

### SUMMARY

One object of the technology disclosed herein is to provide an image display apparatus, an image editing apparatus, an image display program, and an image editing program that make it easy to distinguish between still image data extracted from moving picture data that has already been encoded and still image data generated through a normal shooting process.

In accordance with one aspect of the invention, an image display apparatus is provided that includes a determination unit and a display management unit. The determination unit is configured to determine whether auxiliary information and still image data are stored together. The auxiliary information is stored to indicate that the still image data has been extracted from encoded moving picture data. The display management unit is configured to display a still image and a mark on a display unit. The still image is displayed based on the still image data, and the mark is displayed once the determination unit has determined that the auxiliary information and the still image data are stored together. The mark is also displayed to indicate that the still image data has been extracted from encoded moving picture data.

According to the technology disclosed herein, it is easy to distinguish between still image data extracted from moving picture data that has already been encoded and still image data generated through a normal shooting process.

These and other objects, features, aspects and advantages of the present invention will become apparent to those skilled in the art from the following detailed description, which, taken in conjunction with the annexed drawings, discloses embodiments of the present invention.

### BRIEF DESCRIPTION OF THE DRAWINGS

Referring now to the attached drawings, which form a part of this original disclosure:

FIG. 1 is a front view of a digital camera according to an embodiment;

FIG. 2 is a back view of a digital camera according to an embodiment;

FIG. 3 is a block diagram of a digital camera according to an embodiment;

FIG. 4 is a diagram illustrating the data structure of a JPEG file generated when recording a still image through a normal shooting process according to an embodiment;

FIG. 5 is a diagram illustrating the data structure of a JPEG file generated when recording a still image during moving picture reproduction according to an embodiment;

FIG. 6 is a flowchart illustrating a still image reproduction process according to an embodiment;

FIG. 7 is a diagram illustrating a screen displaying a still image recorded through a normal shooting process according to an embodiment;

FIG. 8 is a diagram illustrating a screen displaying a still image recorded during moving picture reproduction according to an embodiment; and

FIG. 9 is a block diagram illustrating a personal computer according to an embodiment.

### DETAILED DESCRIPTION OF THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

A digital camera 100 according to the present embodiment (an example of an image display apparatus and an image editing apparatus) is an image capturing apparatus that captures moving pictures and still images. The digital camera 100 has a function for capturing still images from a moving picture that is being reproduced. An editing and viewing program 400 (an example of an image display program and an image editing program) is installed in the digital camera 100. The editing and viewing program 400 allows the digital camera 100 to encode captured moving pictures and still images into moving picture data and still image data, respectively, using predetermined compression formats, and record the moving picture data and still image data encoded using the predetermined compression formats in the digital camera 100. Furthermore, the editing and viewing program 400 causes the digital camera 100 to display, in a liquid crystal monitor 123, moving pictures and still images based on the moving picture data and still image data, respectively, that have been encoded using the predetermined compression formats. The moving picture data and still image data that have been encoded using the predetermined compression formats can be outputted from the digital camera 100 to a general-purpose personal computer.

A personal computer 300 according to this embodiment (“PC 300”, hereinafter) (an example of an image display apparatus and an image editing apparatus) is a general-purpose personal computer in which an editing and viewing program 500 (an example of an image display program and an image editing program) is installed. The PC 300 has a function for capturing still images from a moving picture that is being reproduced. The editing and viewing program 500 causes the PC 300 to display, in a liquid crystal display 304a connected to the PC 300, moving pictures and still images based on moving picture data and still image data, respectively, that have been encoded using the predetermined compression formats and outputted from the digital camera 100.

Hereinafter, the configurations and operations of the digital camera 100 and the PC 300 will be described.

### 1. Digital Camera 100

(1-1. Configuration of Digital Camera 100)

Hereinafter, the configuration of the digital camera 100 will be described with reference to the drawings.

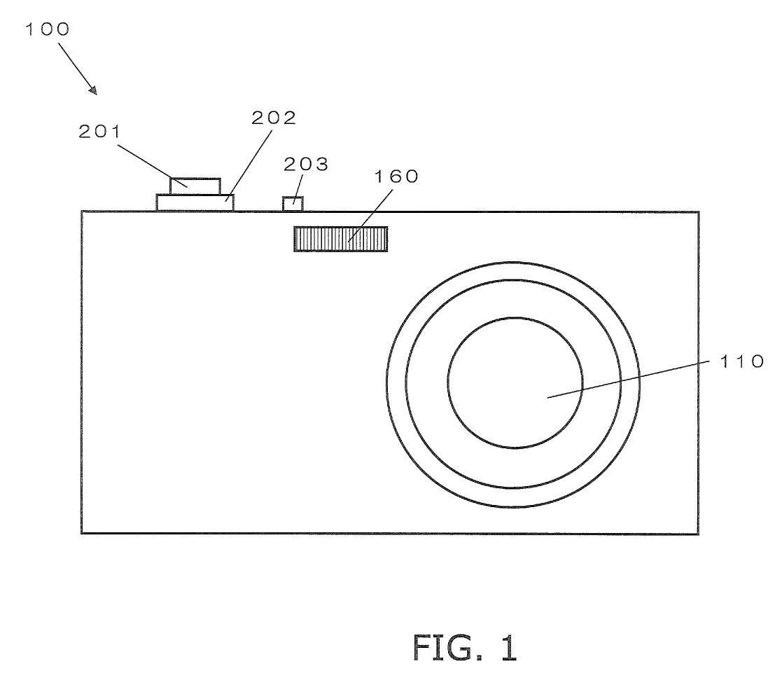

As illustrated in FIG. 1, the digital camera 100 includes, in its front surface, a lens barrel that houses an optical system 110, and a flash 160. The digital camera 100 includes, on its top surface, elements of an operation unit 150 including a still image release button 201, a zoom lever 202, a power button 203, and so on.

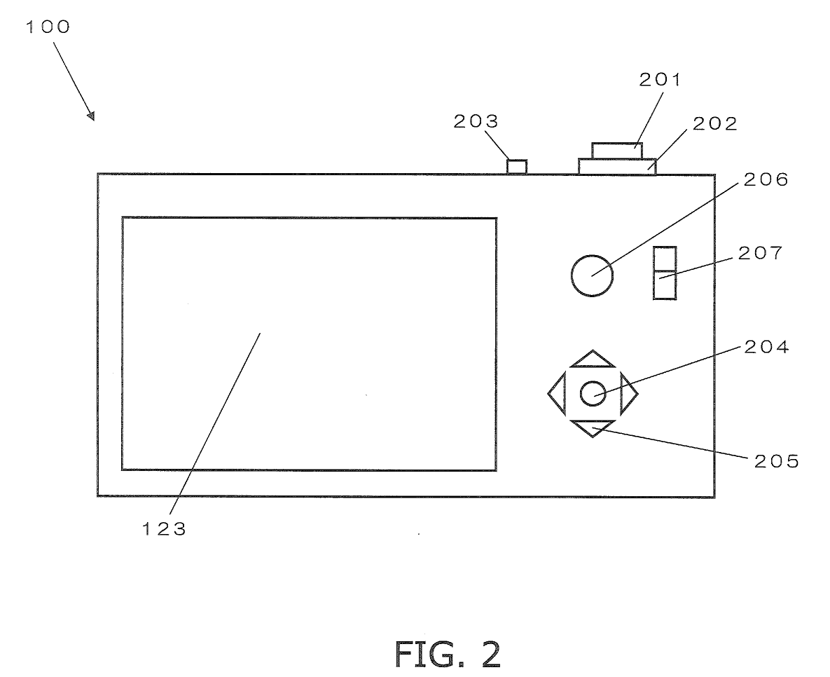

As shown in FIG. 2, the digital camera 100 includes, in its back surface, the liquid crystal monitor 123, and elements of the operation unit 150 including a center button 204, a directional button 205, a moving picture release button 206, a mode toggle switch 207, and so on.

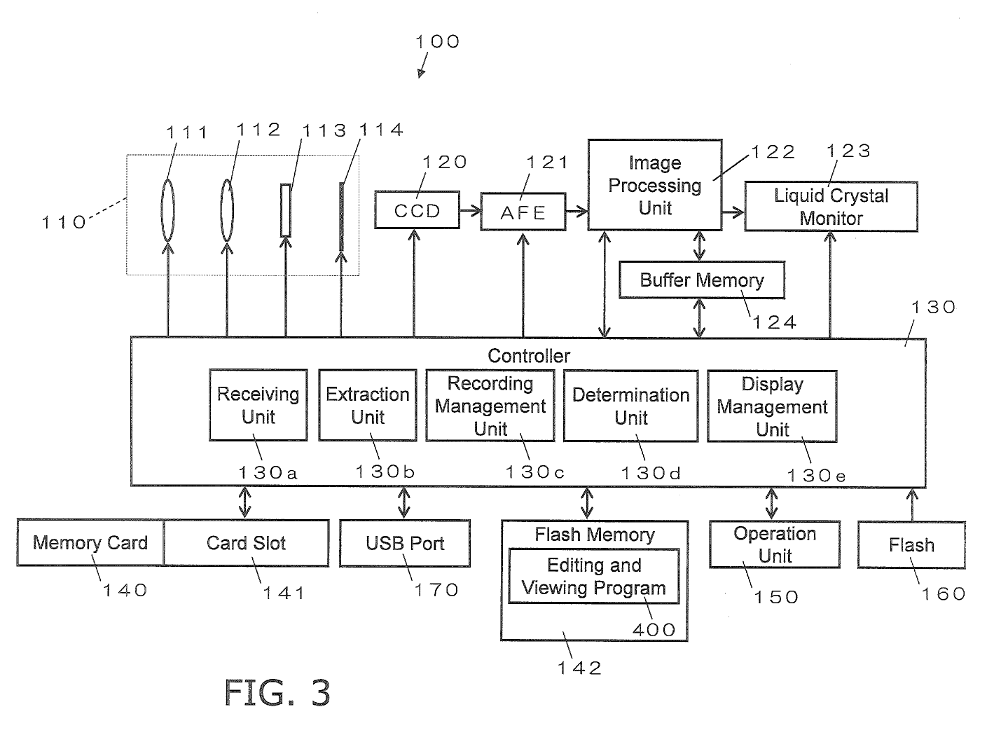

As shown in FIG. 3, the digital camera 100 includes the optical system 110, a CCD image sensor 120, an AFE (analog front end) 121, an image processing unit 122, a buffer memory 124, the liquid crystal monitor 123, a controller 130, a card slot 141, a memory card 140, a flash memory 142, the operation unit 150, the flash 160, and a USB port 170.

The optical system 110 forms an image of a subject. The optical system 110 includes a focus lens 111, a zoom lens 112, an aperture 113, and a shutter 114. In another embodiment, the optical system 110 may include an OIS (Optical Image Stabilizer) lens. The lenses included in the optical system 110 may each includes multiple single lenses, or may each includes multiple groups of lenses.

The focus lens 111 adjusts the focus state of the subject. The zoom lens 112 adjusts the angle of view of the subject. The aperture 113 adjusts the amount of light that enters into the CCD image sensor 120. The shutter 114 adjusts the exposure time of the light that enters into the CCD image sensor 120. The focus lens 111, the zoom lens 112, the aperture 113, and the shutter 114 are each driven by driving units such as DC motors or stepping motors in accordance with control signals from the controller 130.

The CCD image sensor 120 is an imaging element that captures an image of the subject formed by the optical system 110. The CCD image sensor 120 generates image data of a frame in which the captured subject image is present.

The AFE (analog front end) 121 carries out various types of processes on the image data generated by the CCD image sensor 120. Specifically, the AFE 121 carries out processes such as the suppression of noise by correlated double sampling, amplification to the input range of an A/D converter by an analog gain controller, A/D conversion performed by an A/D converter, and so on.

The image processing unit 122 carries out various types of processes on the image data that has been processed by the AFE 121. Specifically, the image processing unit 122 carries out processes such as smear correction, white balance correction, gamma correction, YC conversion processes, electronic zoom processes, and so on. The image processing unit 122 is, in the present embodiment, a microcomputer that executes programs, but may be a hard-wired electronic circuit in another embodiment. The image processing unit 122 may be an integral part of the controller 130 or the like.

The controller 130 carries out the overall control of the operation of the digital camera 100 as a whole. The controller 130 includes a ROM, a CPU, and the like. In addition to programs that handle file control, auto focus control (AF control), automatic exposure control (AE control), and emission control for the flash 160, programs for carrying out the overall control of the operation of the digital camera 100 as a whole are stored in the ROM. The controller 130 operates as a receiving unit 130a, an extraction unit 130b, a recording management unit 130c, a determination unit 130d, and a display management unit 130e by reading out and executing the editing and viewing program 400 from the flash memory 142. The operations of the receiving unit 130a, the extraction unit 130b, the recording management unit 130c, the determination unit 130d, and the display management unit 130e will be described later. The controller 130 is, in the present embodiment, a microcomputer that executes programs, but may be a hard-wired electronic circuit in another embodiment. The controller 130 may be an integral part of the image processing unit 122 or the like.

The image processing unit 122 executes a compression process that encodes image data that has been processed by the AFE 121 and the image processing unit 122 as moving picture data in a predetermined compression format when recording moving pictures and as still image data in a predetermined compression format when recording still images. In the present embodiment, the AVCHD format is employed as the compression format for moving picture data, whereas the JPEG format is employed as the compression format for the still image data. The controller 130 records the moving picture data and still image data encoded using the predetermined compression formats in the memory card 140 and the flash memory 142 (called simply the “memory card 140 or the like” hereinafter).

Note that in the present embodiment, the moving picture data compression process is a lossy compression process. Accordingly, moving picture data obtained by decoding (expanding) moving picture data encoded using the AVCHD format is of a lower image quality than the image data prior to encoding using the AVCHD format. Furthermore, in the present embodiment, a single frame's worth of still image data has a greater resolution than the resolution of the image data of a single frame contained in the moving picture data.

The liquid crystal monitor 123 displays images such as through-the-lens images, recorded images, and so on. The through-the-lens images and recorded images are generated by the image processing unit 122. Through-the-lens images are a series of images based on a series of image data generated continuously by the CCD image sensor 120 at a set time interval while the digital camera 100 is set to a shooting mode. By referring to the through-the-lens image displayed in the liquid crystal monitor 123, a user can capture images while confirming the composition of the subject. Recorded images are images obtained by decoding (expanding) moving picture data and still image data that are encoded in the predetermined compression formats and are recorded in the memory card 140 or the like.

When the operation unit 150 receives an operation from a user instructing the reproduction of a moving picture, the controller 130 reproduces the moving picture (recorded image) by referring to moving picture data in AVCHD format within the memory card 140 or the like. Specifically, first, the controller 130 reads out the moving picture data in the AVCHD format from the memory card 140 or the like. Then, the image processing unit 122 decodes (expands) the moving picture data in the AVCHD format read out by the controller 130. Next, the image processing unit 122 converts the decoded (expanded) moving picture data into moving picture data of a lower resolution that matches the resolution of the liquid crystal monitor 123. Finally, the controller 130 displays a moving picture based on the lower-resolution moving picture data in the liquid crystal monitor 123.

Likewise, when the operation unit 150 receives an operation from a user instructing the reproduction of a still image, the controller 130 reproduces the still image (recorded image) by referring to still image data in the JPEG format within the memory card 140 or the like. Specifically, first, the controller 130 reads out the still image data in the JPEG format from the memory card 140 or the like. Then, the image processing unit 122 decodes (expands) the still image data in the JPEG format read out by the controller 130. Next, the image processing unit 122 converts the decoded (expanded) still image data into still image data of a lower resolution that matches the resolution of the liquid crystal monitor 123. Finally, the controller 130 displays a still image based on the lower-resolution still image data in the liquid crystal monitor 123.

The buffer memory 124 is a volatile storage medium that functions as a work memory for the image processing unit 122 and the controller 130. In the present embodiment, the buffer memory 124 is a DRAM.

The flash memory 142 is an internal memory of the digital camera 100. The flash memory 142 is a non-volatile recording medium. The editing and viewing program 400 is stored in the flash memory 142.

The memory card 140 is inserted, in a removable state, into the card slot 141. The card slot 141 is electrically and mechanically connected to the memory card 140.

The memory card 140 is an external memory of the digital camera 100. The memory card 140 includes a flash memory, which is a non-volatile recording medium.

The operation unit 150 is an operation interface that receives operations from a user. “Operation unit 150” is the collective name for operational buttons, operational dials, and so on located on the outside of the digital camera 100. The operation unit 150 includes the still image release button 201, the moving picture release button 206, the zoom lever 202, the power button 203, the center button 204, the directional button 205, and the mode toggle switch 207. Upon receiving an operation from the user, the operation unit 150 immediately sends a signal indicating the content of the operation to the controller 130.

The still image release button 201 is a two-step push-type button for specifying the timing of still image recording. The still image recording process will be described in further detail later.

The moving picture release button 206 is a push-type button for specifying the timing of starting/ending moving picture recording. When the moving picture release button 206 is depressed by the user, the image processing unit 122 generates moving picture data in the AVCHD format. At approximately the same time, the controller 130 records a moving picture file containing the moving picture data generated by the image processing unit 122 into the memory card 140 or the like. Thereafter, the image processing unit 122 continuously updates the moving picture data in the AVCHD format as new image data is generated by the CCD image sensor 120 at a set time interval, until the moving picture release button 206 is once again depressed by the user. The controller 130 updates the moving picture files within the memory card 140 or the like as the moving picture data in the AVCHD format is continuously updated by the image processing unit 122.

The zoom lever 202 is a lever for adjusting the angle of view between a wide-angle end and a telescopic end. The controller 130 drives the zoom lens 112 based on user operations performed using the zoom lever 202.

The power button 203 is a push-type button for switching the power supply to the respective units of the digital camera 100 between on and off.

The center button 204 and the directional button 205 are push-type buttons. By operating the center button 204 and the directional button 205, the user can display various menu screens in the liquid crystal monitor 123, and can select and set various shooting conditions/reproducing conditions in those menu screens.

The mode toggle switch 207 is a push-type button for switching the digital camera 100 between the shooting mode and the reproduction mode.

The USB port 170 is a communication interface into which a USB connector is inserted in a removable state. When the USB connector on one end of a USB cable is inserted into the USB port 170 and a USB connector on the other end of the USB cable is inserted into a USB port in a general-purpose personal computer, the memory card 140 or the like can be accessed from the general-purpose personal computer. As a result, it is possible to output moving picture data and still image data encoded in predetermined compression formats from the digital camera 100 to the general-purpose personal computer.

(1-2. Recording Process for Still Images Through Normal Shooting Process)

Hereinafter, a recording process for still images through a normal shooting process will be described.

When the still image release button 201 is pressed halfway by the user, the controller 130 executes AF control and AE control. Then, when the still image release button 201 is fully depressed by the user, a still image of a subject formed by the optical system 110 is captured under shooting conditions set automatically or set manually by the user.

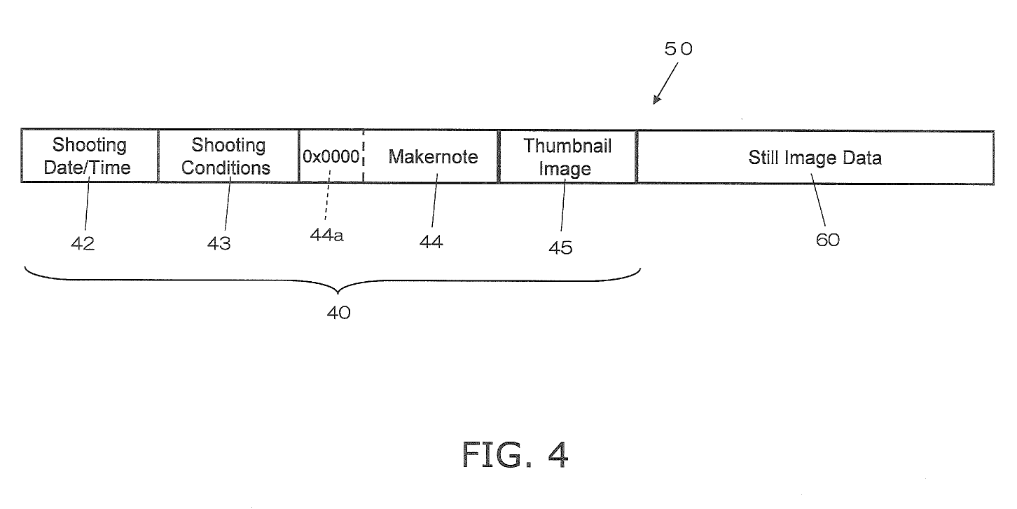

To be more specific, when the still image release button 201 is fully depressed, the CCD image sensor 120 generates image data of a frame in which an image of the subject captured by the CCD image sensor 120 is present. The image data generated by the CCD image sensor 120 is subjected to various types of processes by the AFE 121 and the image processing unit 122. The image processing unit 122 executes, on the image data that has been subjected to the various types of processes by the AFE 121 and the image processing unit 122, a compression process that encodes the image data as still image data in the JPEG format. The controller 130 then creates a JPEG file 50 that contains still image data 60 generated by the image processing unit 122 (see FIG. 4). The still image data 60 is still image data that is in the JPEG format. The controller 130 records the JPEG file 50 into the memory card 140 or the like.

The JPEG file 50 is compliant with the Exif (Exchangeable Image File Format) standard. In addition to the still image data 60, Exif data 40 is included in the JPEG file 50. The Exif data 40 is added information of the still image data 60. The Exif data 40 contains shooting date/time data 42, shooting condition data 43, Makernote data 44, thumbnail image data 45, and so on. The pieces of data 42 to 45 are written in the tag format specified by the Exif standard. Data indicating the shutter speed, F-stop value, exposure time, aperture value, luminosity value, presence/absence of the flash 160, focal distance of the optical system 110, and so on is contained in the shooting condition data 43. A tag called a “Makernote” according to the Exif standard is added to the Makernote data 44. The “Makernote” tag is a tag added to data stored uniquely for individual makers. A flag 44a is included in the Makernote data 44. A tag defined by the maker of the digital camera 100 is added to the flag 44a. The number of the tag added to the flag 44a is “0x001F”, and the type of the flag 44a is “SHORT(0x0003)” (a 16-bit integer). A value of “0x0000”, indicating that the still image data 60 is still image data generated through a normal shooting process, is stored in the flag 44a. The thumbnail image data 45 is generated by the image processing unit 122. Note that the number of the tag added to the flag 44a is not limited to “0x001F” as long as it is a value that can be differentiated from other tags included in the Makernote.

(1-3. Recording Process for Still Images During Moving Picture Reproduction)

Hereinafter, a recording process for still images during moving picture reproduction will be described.

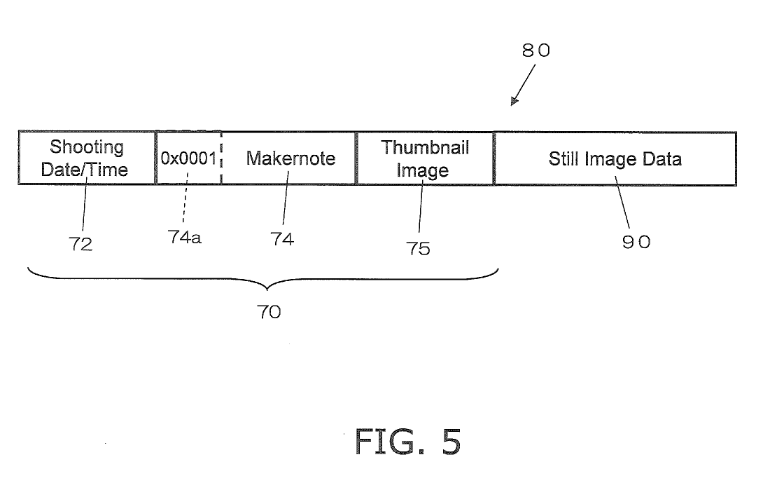

As described earlier, during moving picture reproduction, a moving picture based on the moving picture data in the AVCHD format within the memory card 140 or the like is displayed in the liquid crystal monitor 123. During moving picture reproduction, the receiving unit 130a continuously stands by for a signal from the still image release button 201 indicating that the still image release button 201 has been fully depressed. The extraction unit 130b specifies a single frame displayed in the liquid crystal monitor 123 at the timing at which the receiving unit 130a has received such a signal. Next, the extraction unit 130b captures a still image corresponding to the specified single frame from the moving picture that is being reproduced. To be more specific, the extraction unit 130b extracts the image data of the single specified frame from the decoded (expanded) moving picture data. “Decoded (expanded) moving picture data” is uncompressed moving picture data in the AVCHD format obtained by the image processing unit 122 decoding (expanding) the moving picture data in the AVCHD format. “Image data of the single specified frame” is uncompressed still image data in the JPEG format. Next, the extraction unit 130b executes a compression process that encodes the extracted image data as still image data in the JPEG format. The controller 130 then creates a JPEG file 80 that contains still image data 90 generated by the extraction unit 130b (see FIG. 5). The still image data 90 is still image data that is in the JPEG format. The recording management unit 130c then records the JPEG file 80 in the memory card 140 or the like.

The JPEG file 80 is compliant with the Exif standard. In addition to the still image data 90, Exif data 70 is included in the JPEG file 80. The Exif data 70 is added information of the still image data 90. Shooting date/time data 72, Makernote data 74, thumbnail image data 75, and so on are included in the Exif data 70. The pieces of data 72, 74, and 75 are written in the tag format specified by the Exif standard. A tag called a “Makernote” according to the Exif standard is added to the Makernote data 74. A flag 74a is included in the Makernote data 74. A tag defined by the maker of the digital camera 100 is added to the flag 74a. As with the flag 44a, the number of the tag added to the flag 74a is “0x001F”, and the type of the flag 74a is “SHORT(0x0003)”. A value of “0x0001”, indicating that the still image data 90 is still image data extracted from the moving picture data in the AVCHD format, is stored in the flag 74a. The thumbnail image data 75 is generated by the image processing unit 122.

As can be seen by comparing FIGS. 4 and 5, unlike the Exif data 40 recorded during the normal shooting process, the Exif data 70 recorded during moving picture reproduction does not include the data indicating the shooting conditions. In addition, although a value of “0x0000” indicating that the still image data 60 is still image data generated through a normal shooting process is held in the flag 44a recorded during the normal shooting process, a value of “0x0001” indicating that the still image data 90 is still image data extracted from moving picture data in the AVCHD format is held in the flag 74a recorded during moving picture reproduction.

Incidentally, which frame of still image data 90 will be extracted from specific moving picture data in the AVCHD format depends on the timing at which the still image release button 201 is fully depressed. Accordingly, by receiving a signal indicating that the still image release button 201 has been fully depressed from the still image release button 201 during moving picture reproduction, the receiving unit 130a receives an instruction from the user specifying a frame corresponding to specific still image data 90 to be extracted from specific moving picture data in the AVCHD format. Therefore, it can be said that the extraction unit 130b extracts, from the specific moving picture data in the AVCHD format, the specific still image data 90 corresponding to the frame specified by the instruction received by the receiving unit 130a. Furthermore, it can be said that by recording the JPEG file 80 in the memory card 140 or the like, the recording management unit 130c records the specific still image data 90 extracted by the extraction unit 130b along with the value “0x0001” that indicates that the specific still image data 90 is still image data that has been extracted from the moving picture data in the AVCHD format.

(1-4. Still Image Reproduction Process)

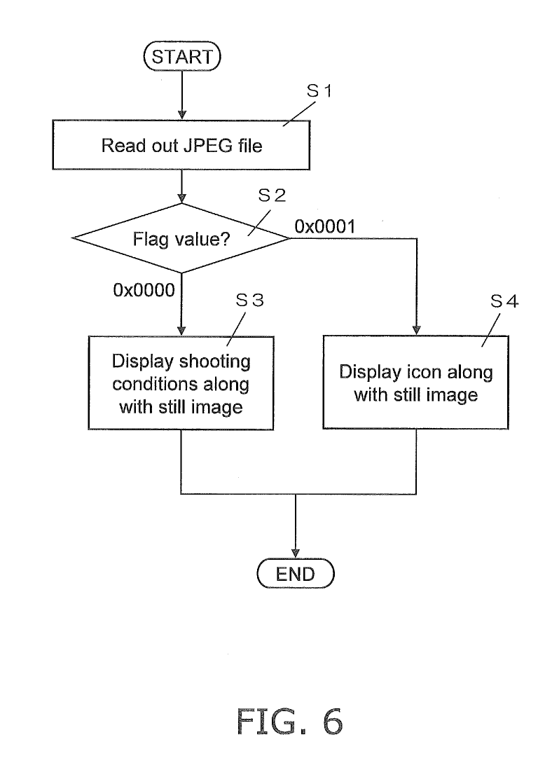

A still image reproduction process will be described hereinafter with reference to FIG. 6. The still image reproduction process is executed at a timing at which the user has selected specific still image data 60/90 (meaning the still image data 60 or the still image data 90; the same applies hereinafter) within the memory card 140 or the like and input an instruction to reproduce a still image based on the specific still image data 60/90 by operating the operation unit 150.

First, the determination unit 130d reads out, from the memory card 140 or the like, the JPEG file 50/80 (the JPEG file 50 or the JPEG file 80; the same applies hereinafter) including the specific still image data 60/90 selected by the user (step S1). Next, the determination unit 130d determines which of the value of “0x0000”, indicating that the specific still image data 60/90 is still image data generated through a normal shooting process, and the value of “0x0001”, indicating that the specific still image data 60/90 is still image data extracted from moving picture data in the AVCHD format, is held in the flag 44a/74a (the flag 44a or the flag 74a; the same applies hereinafter) contained in the Exif data 40/70 (the Exif data 40 or the Exif data 70; the same applies hereinafter) of the JPEG file 50/80 (step S2). Note that the location of the flag 44a/74a contained in the Exif data 40/70 is determined based on the tag value “0x001F” added to the flag 44a/74a. To rephrase, step S2 is a step for determining whether or not the value “0x0001” indicating that the specific still image data 60/90 is still image data extracted from moving picture data in the AVCHD format is recorded within the memory card 140 or the like along with the specific still image data 60/90. In the case where it has been determined that the former value of “0x0000” is stored, the process advances to step S3, whereas in the case where it has been determined that the latter value of “0x0001” is stored, the process advances to step S4. Step S4 is a step that is executed in the case where it has been determined, by the determination unit 130d, that the value “0x0001” indicating that the specific still image data 60/90 is still image data extracted from moving picture data in the AVCHD format is recorded along with the specific still image data 60/90.

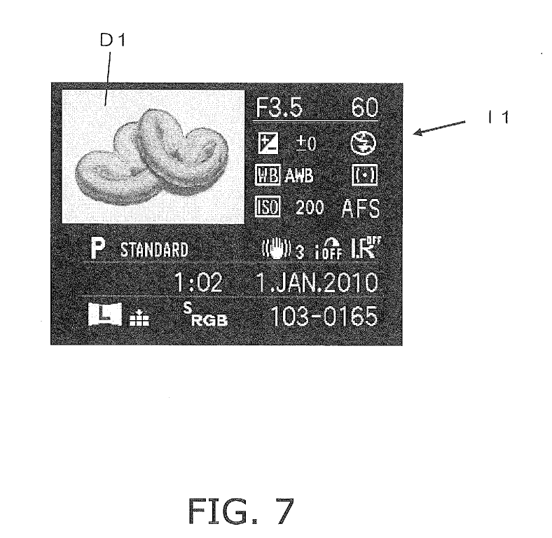

In step S3, the display management unit 130e displays, in the liquid crystal monitor 123, a screen in which the shutter speed and an F-stop value I1 have been superimposed upon a still image D1 based on the specific still image data 60, as shown in FIG. 7. In step S3, an icon I2, which will be described later, is not displayed in the liquid crystal monitor 123. The shutter speed and the F-stop value I1 are specified by referring to the shooting condition data 43 contained in the Exif data 40 that corresponds to the specific still image data 60.

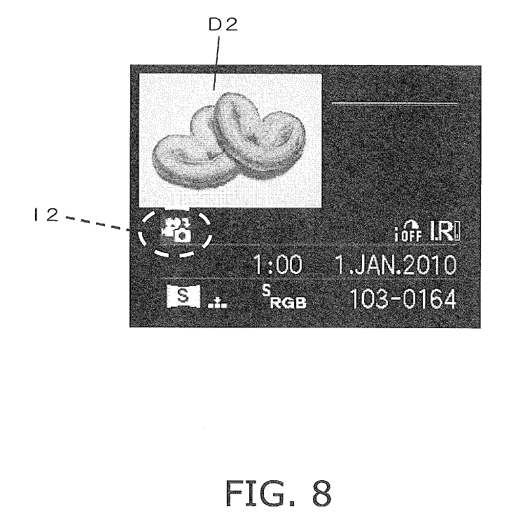

In step S4, the display management unit 130e displays, in the liquid crystal monitor 123, a screen in which the icon I2 has been superimposed upon a still image D2 based on the specific still image data 90, as shown in FIG. 8. The icon I2 is designed so as to indicate that the specific still image data 90 is still image data extracted from moving picture data in the AVCHD format. In step S4, the shutter speed and the F-stop value I1 are not displayed in the liquid crystal monitor 123.

### 2. PC 300

(2-1. Configuration of PC 300)

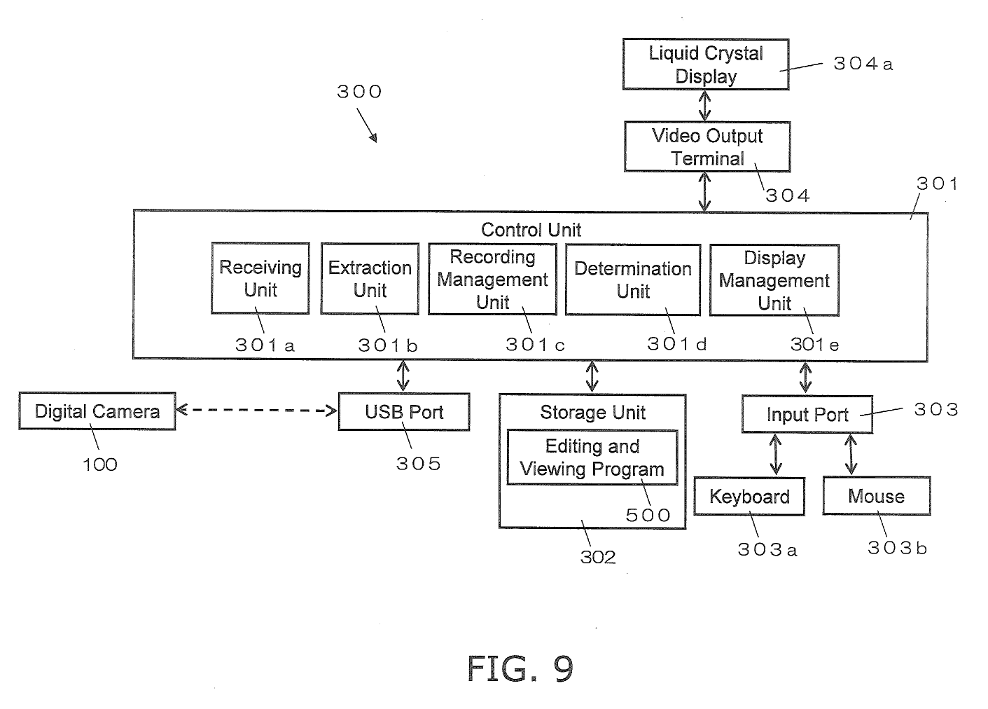

As shown in FIG. 9, the PC 300 is a general-purpose personal computer, and includes a control unit 301, a storage unit 302, an input port 303, a video output terminal 304, and a USB port 305. The control unit 301 includes a CPU, a ROM, a RAM, and the like. The control unit 301 operates as a receiving unit 301a, an extraction unit 301b, a recording management unit 301c, a determination unit 301d, and a display management unit 301e by reading out and executing the editing and viewing program 500 from the storage unit 302. The operations of the receiving unit 301a, the extraction unit 301b, the recording management unit 301c, the determination unit 301d, and the display management unit 301e will be described later. The control unit 301 is, in the present embodiment, a microcomputer that executes programs, but may be a hard-wired electronic circuit in another embodiment. The storage unit 302 is a hard disk, which is a recording medium. The editing and viewing program 500 is installed in the storage unit 302. A keyboard 303a and a mouse 303b are connected to the input port 303. The liquid crystal display 304a is connected to the video output terminal 304. Finally, the digital camera 100 can be connected to the USB port 305 via a USB connector.

When a predetermined operation is made by the user through the keyboard 303a and the mouse 303b while the USB port 305 and the USB port 170 of the digital camera 100 are connected by the USB connector, moving picture files in the AVCHD format and still image files in the JPEG format located within the memory card 140 or the like of the digital camera 100 are copied to the storage unit 302.

An editing and viewing application can be launched by the PC 300 using the editing and viewing program 500. When the editing and viewing application has been launched, the control unit 301 displays an editing and viewing window in the liquid crystal display 304a. Hereinafter, the PC 300 in which the editing and viewing application is running will be described. The PC 300 can reproduce, in the editing and viewing window, moving pictures and still images based on the moving picture files in the AVCHD format and the still image files in the JPEG format, respectively, located in the storage unit 302. The PC 300 can capture still images from a moving picture that is being reproduced.

(2-2. Moving Picture Reproduction Process)

Upon receiving an instruction to reproduce a moving picture from a user through the keyboard 303a and the mouse 303b, the control unit 301 reproduces the moving picture (recorded image) by referring to the moving picture data in the AVCHD format within the storage unit 302. Specifically, first, the control unit 301 reads out the moving picture data in the AVCHD format from the storage unit 302. Then, the control unit 301 decodes (expands) the moving picture data in the AVCHD format that has been read out. Next, the control unit 301 displays a moving picture based on the decoded (expanded) moving picture data in the liquid crystal display 304a.

(2-3. Recording Process for Still Images During Moving Picture Reproduction)

Hereinafter, a recording process for still images during moving picture reproduction will be described.

As described earlier, during moving picture reproduction, a moving picture based on the moving picture data in the AVCHD format within the storage unit 302 is displayed in the liquid crystal display 304a. During moving picture reproduction, the receiving unit 301a continuously stands by for a signal indicating that a predetermined operation has been made by the user in the editing and viewing window via the keyboard 303a and the mouse 303b. The extraction unit 301b specifies a single frame displayed in the editing and viewing window at the timing at which the receiving unit 301a has received such a signal. Next, the extraction unit 301b captures a still image corresponding to the specified single frame from the moving picture that is being reproduced. To be more specific, the extraction unit 301b extracts the image data of the single specified frame from the decoded (expanded) moving picture data. “Decoded (expanded) moving picture data” is uncompressed moving picture data in the AVCHD format obtained by the extraction unit 301b decoding (expanding) the moving picture data in the AVCHD format. “Image data of the single specified frame” is uncompressed still image data in the JPEG format. Next, the extraction unit 301b executes a compression process that encodes the extracted image data as still image data in the JPEG format. The control unit 301 then creates the JPEG file 80 that contains the still image data 90 generated by the extraction unit 301b (see FIG. 5). The still image data 90 is still image data that is in the JPEG format. The recording management unit 301c then records the JPEG file 80 in the storage unit 302.

In addition to the still image data 90, the Exif data 70 is included in the JPEG file 80, as in the case of the digital camera 100. The Exif data 70 contains the flag 74a. A value of “0x0001”, indicating that the still image data 90 is still image data extracted from the moving picture data in the AVCHD format, is stored in the flag 74a.

Incidentally, which frame of still image data 90 will be extracted from specific moving picture data in the AVCHD format depends on the timing at which the predetermined operation has been made in the editing and viewing window. Accordingly, by receiving a signal indicating that the predetermined operation has been made in the editing and viewing window during moving picture reproduction, the receiving unit 301a receives an instruction from the user specifying a frame corresponding to specific still image data 90 to be extracted from specific moving picture data in the AVCHD format. Therefore, it can be said that the extraction unit 301b extracts, from the specific moving picture data in the AVCHD format, the specific still image data 90 corresponding to the frame specified by the instruction received by the receiving unit 301a. Furthermore, it can be said that by recording the JPEG file 80 in the storage unit 302, the recording management unit 301c records the specific still image data 90 extracted by the extraction unit 301b along with the value “0x0001” that indicates that the specific still image data 90 is still image data that has been extracted from the moving picture data in the AVCHD format.

(2-4. Still Image Reproduction Process)

Like the digital camera 100, the PC 300 executes the still image reproduction process illustrated in FIG. 6. In the PC 300, the still image reproduction process is executed at a timing at which the user has selected specific still image data 60/90 (meaning the still image data 60 or the still image data 90; the same applies hereinafter) within the storage unit 302 and input an instruction to reproduce a still image based on the specific still image data 60/90 by performing a predetermined operation in the editing and viewing window via the keyboard 303a and the mouse 303b.

First, the determination unit 301d reads out, from the storage unit 302, the JPEG file 50/80 (the JPEG file 50 or the JPEG file 80; the same applies hereinafter) including the specific still image data 60/90 selected by the user (step S1). Next, the determination unit 301d determines which of the value of “0x0000”, indicating that the specific still image data 60/90 is still image data generated through a normal shooting process, and the value of “0x0001”, indicating that the specific still image data 60/90 is still image data extracted from moving picture data in the AVCHD format, is held in the flag 44a/74a (the flag 44a or the flag 74a; the same applies hereinafter) contained in the Exif data 40/70 (the Exif data 40 or the Exif data 70; the same applies hereinafter) of the JPEG file 50/80 (step S2). Note that the location of the flag 44a/74a contained in the Exif data 40/70 is determined based on the tag value “0x001F” added to the flag 44a/74a. To rephrase, step S2 is a step for determining whether or not the value “0x0001” indicating that the specific still image data 60/90 is still image data extracted from moving picture data in the AVCHD format is recorded within the storage unit 302 along with the specific still image data 60/90. In the case where it has been determined that the former value of “0x0000” is stored, the process advances to step S3, whereas in the case where it has been determined that the latter value of “0x0001” is stored, the process advances to step S4. Step S4 is a step that is executed in the case where it has been determined, by the determination unit 301d, that the value “0x0001” indicating that the specific still image data 60/90 is still image data extracted from moving picture data in the AVCHD format is recorded along with the specific still image data 60/90.

Like the digital camera 100, in step S3, the display management unit 301e displays, in the editing and viewing window, a screen in which the shutter speed and the F-stop value I1 have been superimposed upon the still image D1 based on the specific still image data 60. In step S3, the icon I2, which will be described later, is not displayed in the editing and viewing window. The shutter speed and the F-stop value I1 are specified by referring to the shooting condition data 43 contained in the Exif data 40 that corresponds to the specific still image data 60.

Like the digital camera 100, in step S4, the display management unit 301e displays, in the editing and viewing window, a screen in which the icon I2 has been superimposed upon the still image D2 based on the specific still image data 90. In step S4, the shutter speed and the F-stop value I1 are not displayed in the editing and viewing window.

### 3. Features

In the aforementioned embodiment, unlike the Exif data 40 added to the still image data 60 generated through a normal shooting process, the data indicating the shooting conditions such as shutter speed, F-stop value, and so on is not included in the Exif data 70 added to the still image data 90 extracted from the moving picture data in the AVCHD format. The reason for this is that the data indicating the shooting conditions corresponding to that still image data 90 cannot be obtained in the case where the still image data 90 is extracted from the moving picture data in the AVCHD format.

In the present embodiment, the moving picture data compression process is a lossy compression process. Therefore, when the moving picture data is decoded (expanded) after having been encoded in the predetermined compression format, part of that moving picture data information is lost. Meanwhile, a single frame of still image data has a higher resolution than a single frame of moving picture data. As a result, the still image data 90 extracted from the moving picture data in the AVCHD format is worse in terms of image quality than the still image data 60 generated through a normal shooting process.

In the digital camera 100 and the PC 300, in the case where the still image D2 based on the still image data 90 extracted from the moving picture data in the AVCHD format is reproduced, the icon I2 is displayed instead of the shutter speed and the F-stop value I1. Accordingly, based on the presence/absence of the icon I2, the user can easily distinguish between the still image D2 based on the still image data 90 extracted from the moving picture data in the AVCHD format and the still image D1 based on the still image data 60 generated from a normal shooting process. To take this from a different perspective, in the case where the shutter speed and F-stop value I1 are not displayed while playing back the still image D2, the image quality of the still image D2 is worse than expected, and so on, the user can easily understand the reason why such a situation has occurred. Accordingly, the manufacturer of the digital camera 100 can also expect a drop in complaints from users.

### 4. Other Embodiments

The techniques disclosed here are not intended to be limited to the aforementioned embodiment, and various other embodiments thereof are conceivable as well. The following are examples thereof.

In the aforementioned embodiment, the icon I2 is displayed as a mark indicating that the still image data 90 is still image data extracted from the moving picture data in the AVCHD format. However, the mark indicating that the still image data 90 is still image data extracted from the moving picture data in the AVCHD format is not limited to the icon I2, and any design or the like that incorporates at least one of a graphic, a symbol, and a character, for example, can be employed.

In the aforementioned embodiment, the AVCHD format is employed as the compression format for moving picture data, whereas the JPEG format is employed as the compression format for the still image data. However, other compression formats may be employed. For example, the Motion JPEG format may be employed as the compression format for the moving picture data. In the case where still image data in the JPEG format is to be extracted from moving picture data in the Motion JPEG format, it is not necessary to decode (expand) the moving picture data in the Motion JPEG format. However, unlike the still image data 60 generated through a normal shooting process, data indicating the shooting conditions such as the shutter speed, F-stop value, and so on is not added to the still image data in the JPEG format extracted from the moving picture data in the Motion JPEG format. Furthermore, still image data in the JPEG format extracted from moving picture data in the Motion JPEG format can be worse in terms of image quality than the still image data 60 generated through a normal shooting process. Therefore, it is valuable to notify the user that the still image data 90 is still image data extracted from the moving picture data in the Motion JPEG format using the icon I2 or the like.

In the aforementioned embodiment, still image data is extracted from moving picture data having waited for an instruction from a user specifying a frame during moving picture reproduction. However, rather than during moving picture reproduction, still image data may be extracted from the moving picture data in the AVCHD format within the memory card 140 or the like and the storage unit 302 at a predetermined time interval. Alternatively, a frame in which a characteristic partial image, such as a face, is present may automatically be recognized in the moving picture data in the AVCHD format within the memory card 140 or the like and the storage unit 302, and the still image data of that frame may be automatically extracted.

In the aforementioned embodiment, when playing back the still image data 60/90, whether or not to display the icon I2 is determined by referring to the value of the flag 44a/74a to which a predetermined tag has been added. However, the value of the flag 44a/74a to which the predetermined tag has been added may be referred to at other timings and/or for other purposes. For example, by referring to the value of the flag 44a/74a when a list of the still image data 60/90 within the memory card 140 or the like and the storage unit 302 is displayed, the shooting conditions such as shutter speed, F-stop value I1, and so on may be displayed for the still image data 60, whereas the reasons for not being able to display the shooting conditions such as the shutter speed, the F-stop value I1, and so on may be displayed using the icon I2 or another form thereof for the still image data 90.

In the aforementioned embodiment, the tags for recording data indicating the shooting conditions themselves are not recorded in the Exif data 70 added to the still image data 90 extracted from the moving picture data in the AVCHD format as illustrated in FIG. 5; however, the technique is not limited thereto, and the still image data 90 may have, added thereto, Exif data 70 in which tags for recording data indicating the shooting conditions are recorded but valid values are not present for the tag values. For example, the values of the tags indicating the shooting conditions are all set to 0. The process illustrated in FIG. 6 may be carried out when playing back this still image data as well, with step S4 executed after it has been confirmed that the value of the flag 74a is “0x0001”. In other words, the value of the tag of the number “0x001F” included in the Makernote can be referred to and the display format switched based on that value, regardless of the presence/absence of recording of the data that indicates the shooting conditions.

In the aforementioned embodiment, in the process for recording a still image during moving picture reproduction, the receiving unit 130a continuously stands by for a signal indicating that the still image release button 201 has been fully depressed during the moving picture reproduction, but the technique is not limited thereto as long as a single frame can be specified. For example, the depression of the center button 204 may be employed instead of the depression of the still image release button 201. In addition, the single frame may be specified during trick play, such as fast-forwarding, rewinding, slow-motion reproduction, pause, or the like, rather than during reproduction.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “unit”, “part,” “section,” “portion,” “member” or “element” when used in the singular can have the dual meaning of a single part or a plurality of parts. Accordingly, these terms, as utilized to describe the present invention, should be interpreted relative to an image display apparatuses and an image editing apparatuses.

The term “configured” as used herein to describe a component, section or part of a device includes hardware and/or software that is constructed and/or programmed to carry out the desired function.

The term “program” as used herein to describe processes include a sequence of coded instructions fed into an electronic device (e.g. a computer or a digital camera) enabling the electronic device to perform specified logical and arithmetical operations.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An image display apparatus comprising:
a determination unit configured to determine whether auxiliary information and still image data are stored together, the auxiliary information being stored to indicate that the still image data has been extracted from encoded moving picture data; and
a display management unit configured to display a still image and a mark on a display unit, the still image being displayed based on the still image data, and the mark being displayed once the determination unit has determined that the auxiliary information and the still image data are stored together, the mark indicating that the still image data has been extracted from encoded moving picture data.

2. The image display apparatus according to claim 1, wherein the mark includes at least one of a graphic, a symbol, and a character.

3. The image display apparatus according to claim 2, wherein the mark is displayed on the display unit at the same time as the still image.

4. An image editing apparatus comprising:
an extraction unit configured to extract still image data from encoded moving picture data; and
a recording management unit configured to record and store auxiliary information and the extracted still image data, the auxiliary information being stored to indicate that the still image data has been extracted from encoded moving picture data.

5. The image editing apparatus according to claim 4, further comprising
a determination unit configured to determine whether the auxiliary information and the extracted still image data are stored together; and
a display management unit configured to display a still image and a mark on a display unit, the still image being displayed based on the extracted still image data, and the mark being displayed once the determination unit has determined that the auxiliary information and the extracted still image data are stored together, the mark indicating that the still image data has been extracted from encoded moving picture data.

6. The image editing apparatus according to claim 4, further comprising
a receiving unit configured to receive instructions specifying a frame that corresponds to the still image data to be extracted from the moving picture data, the instructions being provided by a user.

7. An image display program configured to cause an electronic device to perform the processes of:
determining whether auxiliary information and still image data are stored together on the electronic device using a determination unit; and
displaying a still image and a mark on a display connected to the electronic device using a display management unit.

8. The image display program according to claim 7, wherein
the auxiliary information indicates that the still image data has been extracted from encoded moving picture data.

9. The image display program according to claim 7, wherein
the displaying of the still image is based on the still image data, and the displaying of the mark is performed once the determination unit has determined that the auxiliary information and the still image data are stored together, the mark being provided to indicate that the still image data has been extracted from encoded moving picture data.

10. The image display program according to claim 9, wherein
the displaying of the still image and the mark on the display includes displaying the still image and the mark at the same time.

11. The image display program according to claim 10, wherein
the electronic device is a computer.

12. An image editing program configured to cause an electronic device to perform the processes of:
extracting still image data from encoded moving picture data using an extraction unit connected to the electronic device; and
recording and storing auxiliary information and the still image data on the electronic device using a recording management unit connected to the electronic device, the auxiliary information being stored together with the still image data to indicate that the still image data has been extracted from the moving picture data.

13. The image editing program according to claim 12, wherein
the electronic device is a computer.
